(19) United States
(12) Patent Application Publication
(10) Pub. No.: US 2025/0178002 A1
(43) Pub. Date: Jun. 5, 2025

(54) HOUSEHOLD APPLIANCE APPARATUS

(71) Applicant: LIXIL Corporation, Tokyo (JP)

(72) Inventors: Tetsurou MATSUMOTO, Tokyo (JP); Shinichi GOMITA, Tokyo (JP); Shuhei HAIDA, Tokyo (JP)

(73) Assignee: LIXIL Corporation, Tokyo (JP)

(21) Appl. No.: 18/844,352

(22) PCT Filed: Jan. 16, 2023
(86) PCT No.: PCT/JP2023/000998

§ 371 Date: Sep. 5, 2024

(30) Foreign Application Priority Data
Mar. 10, 2022 (JP) 2022-037196
Mar. 10, 2022 (JP) 2022-037198

(51) Int. Cl. B05B 1/08; B05B 1/12

(52) U.S. Cl. CPC B05B 1/08; B05B 1/12

(57) ABSTRACT

A housing equipment device includes a fluidic oscillator, a branch flow path connected to a discharge port of the fluidic oscillator and having multiple branch outlets, and multiple flow path outlets that each are connected to one of the multiple branch outlets and through which a fluid from each of the branch outlets is discharged to open space. Pulsating flows are discharged through the flow path outlets, and the sum of the cross-sectional areas of the narrowest portions in fluid passages located downstream of the discharge port of the fluidic oscillator is greater than or equal to the cross-sectional area of the discharge port of the fluidic oscillator.

### CROSS-REFERENCE TO RELATED APPLICATIONS

This application is a national stage application under 35 USC 371 of International Application No. PCT/JP2023/000998, filed Jan. 16, 2023, which claims the priority of Japanese Application No. 2022-037196, filed Mar. 10, 2022, and Japanese Application No. 2022-037198, filed Mar. 10, 2022. The entire contents of each priority application are incorporated herein by reference.

### FIELD

A first disclosure relates to a housing equipment device.

### BACKGROUND

The background of the first disclosure will be described. For example, Japanese Translation of PCT International Application Publication No. 2008-517762 describes a fluidic oscillator that operates on a pressurized fluid to generate an exhaust flow in the form of an oscillating spray of fluid droplets. This oscillator includes an inlet for the fluid, a pair of power nozzles, a pathway having a boundary surface that includes a pair of sidewalls between the inlet and the power nozzles, an interaction chamber that receives the flow from the nozzles, and a means for increasing the instability of the flow from the power nozzles. This oscillator is configured with a purpose of generating oscillating fluid jets with spatially uniform droplet distributions over a wide range of operating temperatures.

### SUMMARY

### Technical Problem

The inventors of the subject application examined the mechanism for discharging pulsating flows from multiple outlets and obtained the following new recognition. The fluidic oscillator described in the Japanese Translation of PCT International Application Publication No. 2008-517762 can generate a single oscillating fluid jet but cannot generate multiple fluid jets. In order to generate multiple fluid jets using this oscillator, multiple fluidic oscillators need to be provided, so that this oscillator is disadvantageous for downsizing.

A purpose of the first disclosure is to provide a housing equipment device that is advantageous for downsizing and that can discharge pulsating flows through multiple outlets.

### Solution to Problem

To solve the aforementioned issue, one embodiment of the first disclosure is a housing equipment device. A housing equipment device according to one embodiment includes: a fluidic oscillator; a branch flow path connected to a discharge port of the fluidic oscillator and having multiple branch outlets; and multiple flow path outlets that each are connected to one of the multiple branch outlets and through which a fluid from each of the branch outlets is discharged to open space. Pulsating flows are discharged through the flow path outlets, and the sum of the cross-sectional areas of the narrowest portions in fluid passages located downstream of the discharge port of the fluidic oscillator is greater than or equal to the cross-sectional area of the discharge port of the fluidic oscillator.

### BRIEF DESCRIPTION OF DRAWINGS

FIG. 1 is a perspective view of a housing equipment device according to a first embodiment.

FIG. 2 is a plan view that shows an example of the housing equipment device according to the first embodiment.

FIG. 3 is a first diagram that shows a process of oscillation of a fluidic oscillator.

FIG. 4 is a second diagram that shows a process of oscillation of the fluidic oscillator.

FIG. 5 is a third diagram that shows a process of oscillation of the fluidic oscillator.

FIG. 6 is a fourth diagram that shows a process of oscillation of the fluidic oscillator.

FIG. 7 is a plan view that shows internal spaces of transmission flow paths in the housing equipment device according to the first embodiment.

FIG. 8 is a first diagram that shows a flow of a fluid in the housing equipment device according to the first embodiment.

FIG. 9 is a second diagram that shows a flow of a fluid in the housing equipment device according to the first embodiment.

FIG. 10 is a third diagram that shows a flow of a fluid in the housing equipment device according to the first embodiment.

FIG. 11 is a diagram that shows flow rate changes of a first pulsating flow and a second pulsating flow.

FIG. 12 is a diagram that shows a vertical cross section taken along line A-A in FIG. 1.

FIG. 13 is a diagram that shows a transverse cross section of the housing equipment device in FIG. 1 taken along line B-B.

FIG. 14 is a diagram that shows a vertical cross section of the housing equipment device in FIG. 1 taken along line C-C.

FIG. 15 is a diagram that shows a transverse cross section of the housing equipment device in FIG. 1 taken along line D-D.

FIG. 16 is a diagram that shows an example of an intake opening of the housing equipment device according to the first embodiment.

FIG. 17 is a diagram that shows an example of a protrusion of the housing equipment device according to the first embodiment.

FIG. 18 is a perspective view of a housing equipment device according to a second embodiment.

FIG. 19 is a plan view that shows an example of the housing equipment device according to the second embodiment.

FIG. 20 is a plan view that shows a first discharge mode of the housing equipment device according to the second embodiment.

FIG. 21 is a plan view that shows a second discharge mode of the housing equipment device according to the second embodiment.

FIG. 22 is a plan view that shows a state in which two sidewalls of the housing equipment device according to the second embodiment have been rotated.

FIG. 23 is a plan view that shows another example of the first discharge mode of the housing equipment device according to the second embodiment.

FIG. 24 is a plan view that shows another example of the second discharge mode of the housing equipment device according to the second embodiment.

### DETAILED DESCRIPTION

There will now be described embodiments related to the first disclosure and a second disclosure. In the following description, like reference characters denote like constituting elements, and repetitive description will be omitted. In each drawing, part of the constituting elements may be appropriately omitted, enlarged, or reduced, for the sake of convenience. Each drawing is to be viewed according to the orientation of the reference characters. The structures and shapes referred to in the present specification include not only structures and shapes that exactly match what is mentioned in the present specification, but also structures and shapes that deviate by the amount of errors, such as dimensional errors and manufacturing errors. In each drawing, part of a member less important in describing the embodiments may be omitted.

Terms including ordinal numbers, such as “first” and “second”, are used to describe various constituting elements. However, such terms are used only to distinguish one constituting element from another and do not limit the configurations of the first disclosure and the second disclosure. Also, each of the following embodiments is provided as an example to assist in understanding of the first disclosure and the second disclosure and does not limit the configurations of the first disclosure and the second disclosure.

The technologies of the first disclosure and the second disclosure are applicable to various types of housing equipment devices equipped with a discharge device that discharges a fluid. This fluid is not limited and may be a gas, a liquid, or a multiphase fluid. As an example, housing equipment devices of the first disclosure and the second disclosure can be applied to a device that discharges a liquid. Examples of such a device include a shower, faucet, sprinkler system, and chemical spraying device. As an example, the housing equipment devices of the first disclosure and the second disclosure can be applied to a device that discharges a gas. Examples of such a device include a dryer, hair dryer, hand dryer, and heating and cooling equipment. As an example, the housing equipment devices of the first disclosure and the second disclosure can be applied to a device that discharges a multiphase fluid. Examples of such a device include a bathroom shower and a hand washing faucet device for water containing bubbles.

### First Embodiment

In terms of usability and design, it is desirable to downsize a housing equipment device, and such downsizing can expand the applicable range of the device. When a device that generates a single fluid jet is used, such as the oscillator described in the Japanese Translation of PCT International Application Publication No. 2008-517762, multiple fluidic oscillators need to be provided to generate multiple fluid jets, which is disadvantageous for downsizing.

In order to discharge pulsating flows through multiple outlets, a configuration with a moving part, such as an impeller and a gear, added is also conceivable. However, in this case, a failure may occur due to wear of the moving part or dust caught in the moving part, for example.

The housing equipment device according to the first disclosure is made based on these findings and can implement multiple pulsating flows without using a moving part. Since there is no moving part, a failure due to wear thereof or dust caught therein scarcely occurs. As an example, when applied to the cleaning use, the multiple pulsating flows may provide a favorable cleaning effect. Also, as an example, when applied to the use of discharging toward a human body, the multiple pulsating flows may provide a favorable massage sensation. In the following, the technology of the first disclosure will be described with reference to the first embodiment.

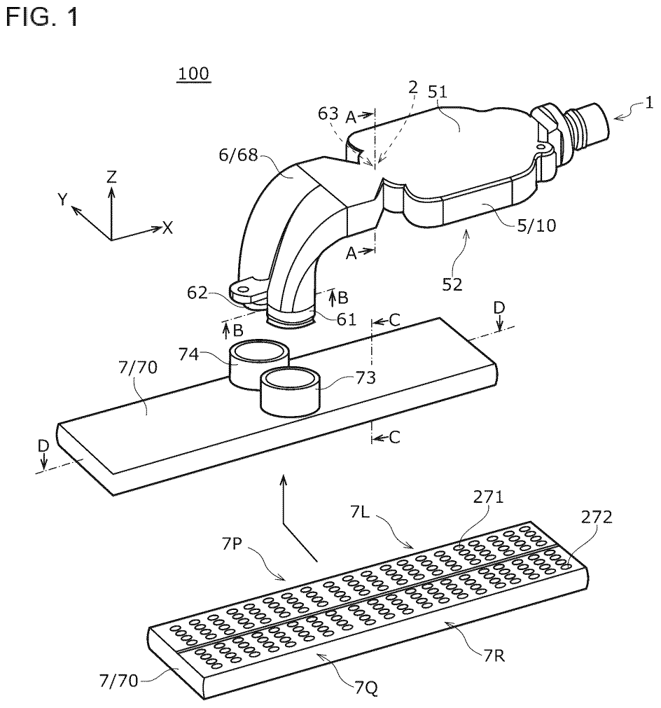

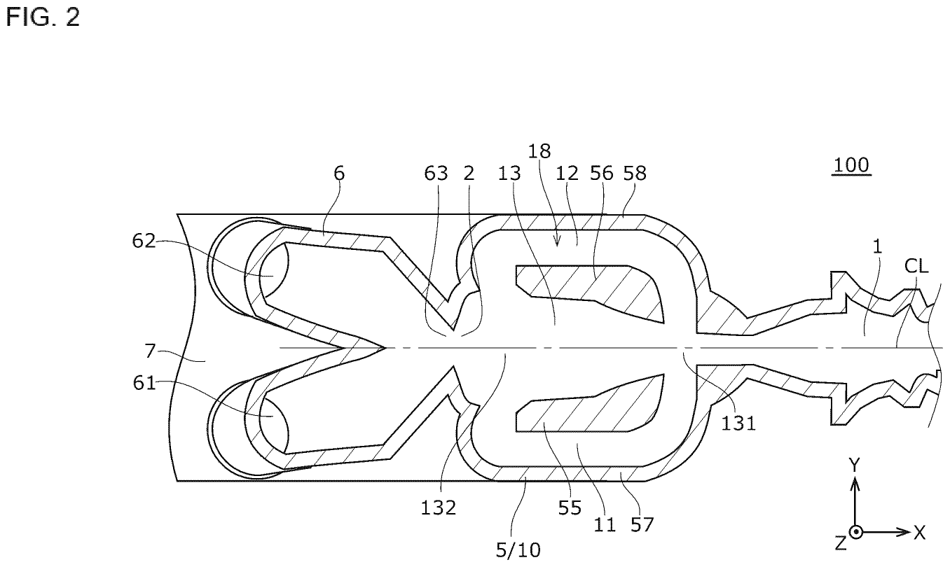

There will now be described devised features of a housing equipment device 100 according to the first embodiment. FIG. 1 and FIG. 2 are now referred to. The first embodiment of the first disclosure is the housing equipment device 100 that can be used as a water discharge device, which discharges hot water and water toward a human body to provide a massage sensation. Hereinafter, the housing equipment device 100 may also be referred to as the device 100. The device 100 includes a fluidic oscillator 10, a branch flow path 6 that is connected to a discharge port 2 of the fluidic oscillator 10 and has multiple branch outlets 61 and 62, and multiple transmission flow paths 7L and 7R that have multiple flow path outlets 271 and 272 through which the fluid from each of the multiple branch outlets 61 and 62 is discharged to open space. The multiple transmission flow paths 7L and 7R are flow paths formed in multiple internal spaces 7P and 7Q. Through the multiple transmission flow paths 7L and 7R, multiple pulsating flows are discharged. The multiple pulsating flows discharged through the multiple transmission flow paths 7L and 7R may vary in flow rate with the same period in different phases from each other. In the description of the first embodiment, a flow that jets out from a small hole to open space will be referred to as a “jet flow”, a fluctuating jet flow will be referred to as a “fluctuating flow”, and a pulsating jet flow will be referred to as a “pulsating flow”. In concept, the jet flow includes the fluctuating flow and the pulsating flow.

In the description of the first embodiment, the period of a pulsating flow means the period of time variation in the flow rate of the pulsating flow, and the phases of multiple pulsating flows being different include the timing of a maximum flow rate of each of the multiple pulsating flows being different. When one of the multiple pulsating flows with the same period has a maximum flow rate while another thereof has a minimum flow rate, it is said that they are in opposite phases. The period may be constant or may vary.

For the sake of convenience, on a plane as shown in the figure, front and rear directions on the plane along the discharge direction of the fluidic oscillator 10 will be referred to as X directions, left and right directions perpendicular to the front and rear directions on the plane will be referred to as Y directions, and vertical up and down directions will be referred to as Z directions. In the X directions, the direction of the arrow will be referred to as “rear” or “rearward”, and the direction opposite to the arrow direction will be referred to as “front” or “frontward”. In the Y directions, the direction of the arrow will be referred to as “right” or “rightward”, and the direction opposite to the arrow direction will be referred to as “left” or “leftward”. An X direction, a Y direction, and a Z direction are perpendicular to each other. This is not limited to the case where they are strictly perpendicular, but also includes the case where they are nearly perpendicular. Such description regarding directions does not limit the posture of the device 100 during its use, and the device 100 may be used in any posture depending on the application.

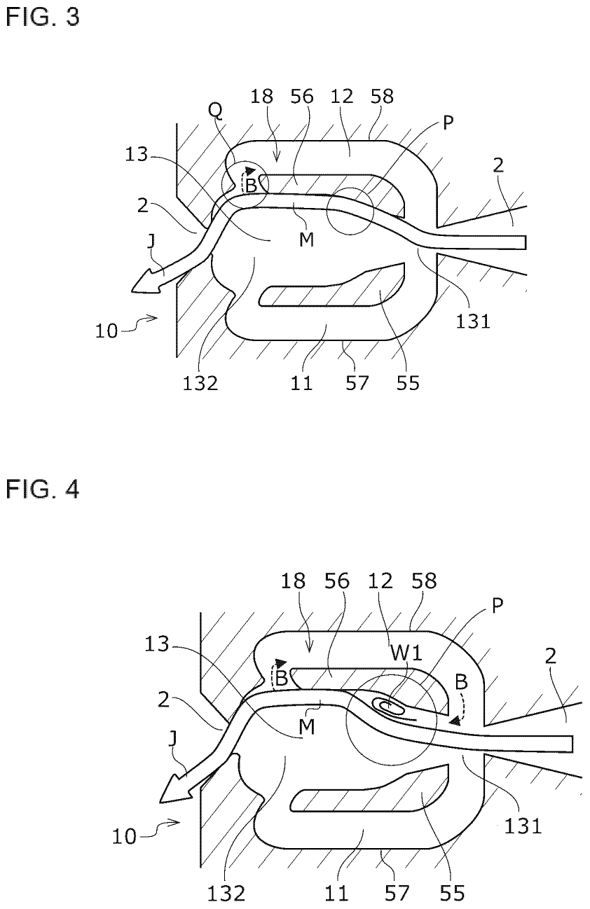

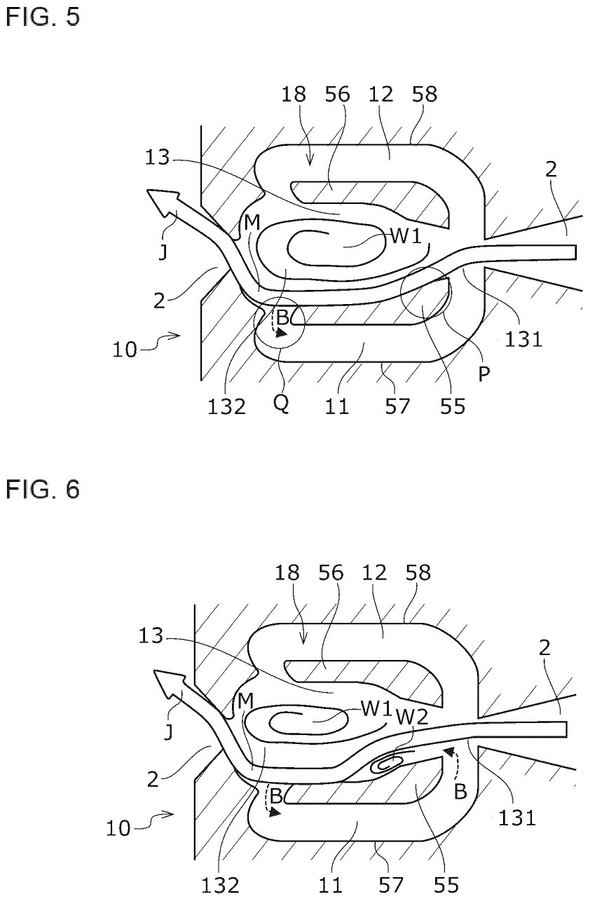

With reference also to FIG. 3, FIG. 4, FIG. 5, and FIG. 6, the operating principle of the fluidic oscillator 10 according to the present embodiment will be described. As shown in FIG. 3, when a main fluid M is flowing closer to a second intermediate wall 56 side, the main fluid M flows along the wall surface of the second intermediate wall 56 due to the Coanda effect (the circle P). At the time, a feedback fluid B flows into a second feedback path 12 (the circle Q).

As shown in FIG. 4, the feedback fluid B that has flowed through the second feedback path 12 applies pressure to the main fluid M in an upstream part 131. The main fluid M is pushed by the pressure from the feedback fluid B and separates from the second intermediate wall 56, and a vortex W1 is generated in the space formed after the separation (the circle P).

As shown in FIG. 5, the vortex W1 gradually grows into a large vortex and applies pressure to the main fluid M toward a first intermediate wall 55. When the main fluid M approaches the first intermediate wall 55, the main fluid M flows along the wall surface of the first intermediate wall 55 due to the Coanda effect (the circle P). At the time, a feedback fluid B flows into a first feedback path 11 (the circle Q).

As shown in FIG. 6, the feedback fluid B that has flowed through the first feedback path 11 applies pressure to the main fluid M in the upstream part 131. The main fluid M is pushed by the pressure from the feedback fluid B and separates from the first intermediate wall 55; a second vortex W2 is generated in the space formed after the separation, and the vortex W1 becomes smaller and smaller. Thus, the vortex W1 between the main fluid M and the second intermediate wall 56 and the vortex W2 between the main fluid M and the first intermediate wall 55 are alternately generated and repeat growing and shrinking, so that the fluidic oscillator 10 reaches an oscillation state in which the discharge direction of the main fluid M changes periodically. As a result, the fluidic oscillator 10 discharges a wavy flow J through the discharge port 2. As shown in these figures, the wavy flow J can be said to be a flow of fluid of which the traveling direction swings.

With reference to FIG. 1 and FIG. 2, the branch flow path 6 will be described. The branch flow path 6 includes a branch inlet 63 connected to the discharge port 2, and the multiple branch outlets 61 and 62. The branch inlet 63 is provided at an upstream end of a branch flow path body 68, and the branch outlets 61 and 62 are provided at a downstream end of the branch flow path body 68. In the example of FIG. 1, the fluid that flows in the front direction from the branch inlet 63 branches in two directions in the branch flow path 6, is bent approximately 90 degrees, and is discharged downward through each of the branch outlets 61 and 62.

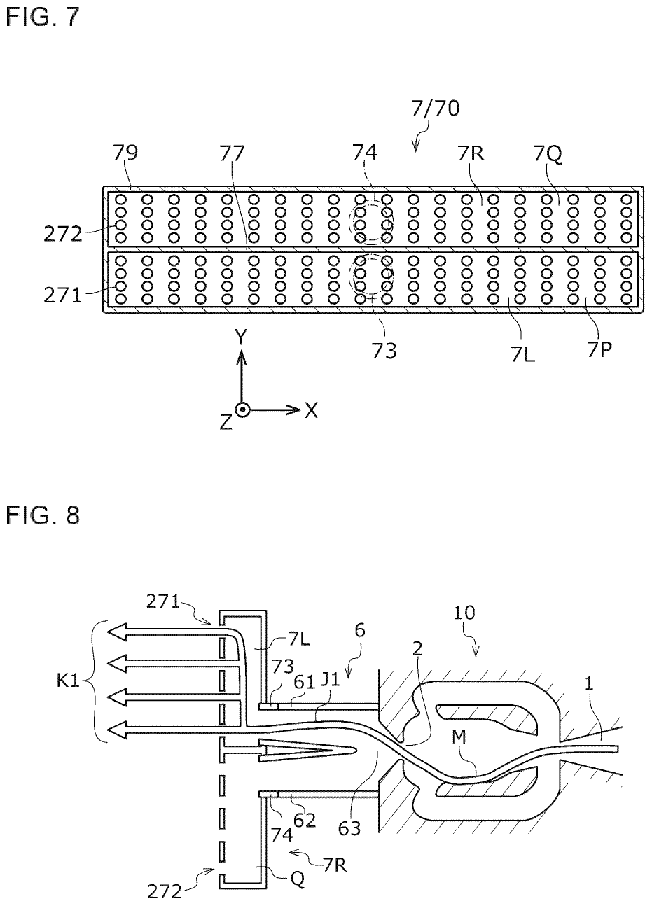

With reference to FIG. 1 and FIG. 7, the multiple transmission flow paths 7L and 7R will be described. The multiple transmission flow paths 7L and 7R may be collectively referred to as transmission flow paths 7. In FIG. 7, the internal spaces of the multiple transmission flow paths 7L and 7R are shown in an exposed state. The transmission flow paths 7 include a transmission flow path body 70, transmission inlets 73 and 74 connected to the branch outlets 61 and 62, and the flow path outlets 271 and 272 through which the fluid from each of the transmission inlets 73 and 74 is discharged to open space. In the example of FIG. 1, the transmission flow path 7L includes the transmission inlet 73, and multiple (80 in this example) flow path outlets 271 arranged in a matrix of multiple rows (20 rows in this example) and multiple columns (4 columns in this example). The transmission flow path 7R includes the transmission inlet 74, and multiple (80 in this example) flow path outlets 272 arranged in a matrix of multiple rows (20 rows in this example) and multiple columns (4 columns in this example).

The transmission flow path body 70 is an outer shell that surrounds the transmission flow paths 7L and 7R. The transmission flow path body 70 is a vertically flattened box with its long side directions in the front and rear directions and shows a rectangular shape in plan view. The transmission flow path 7L communicates with the transmission inlet 73 and the flow path outlets 271, and the transmission flow path 7R communicates with the transmission inlet 74 and the flow path outlets 272. The transmission inlets 73 and 74 are pipe-shaped portions protruding upward from a ceiling part of the transmission flow path body 70 and communicate with the upper side of the internal spaces. The transmission inlets 73 and 74 are aligned left and right along a bisector with respect to the front and rear directions of the ceiling part. The transmission inlets 73 and 74 are arranged along the left and right directions. The flow path outlets 271 and 272 are openings provided in a bottom part of the transmission flow path body 70 and communicate with the lower side of the internal spaces.

The internal space of the transmission flow path body 70 is a space surrounded by a peripheral wall 79 and is partitioned into left and right sides by a partition wall 77 extending along a bisector with respect to the left and right directions of the bottom part. The transmission flow path 7L includes the space on the left side of the partition wall 77, and the transmission flow path 7R includes the space on the right side of the partition wall 77.

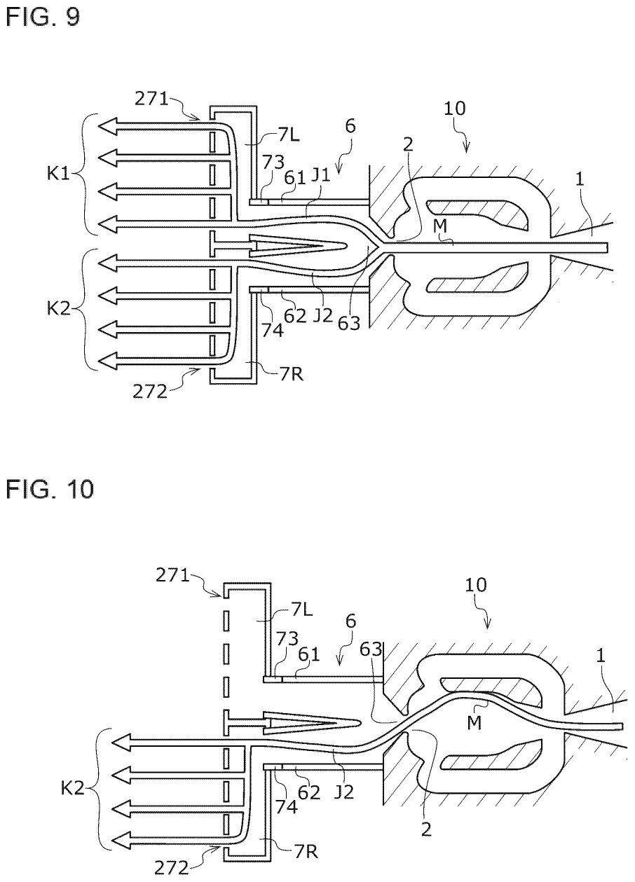

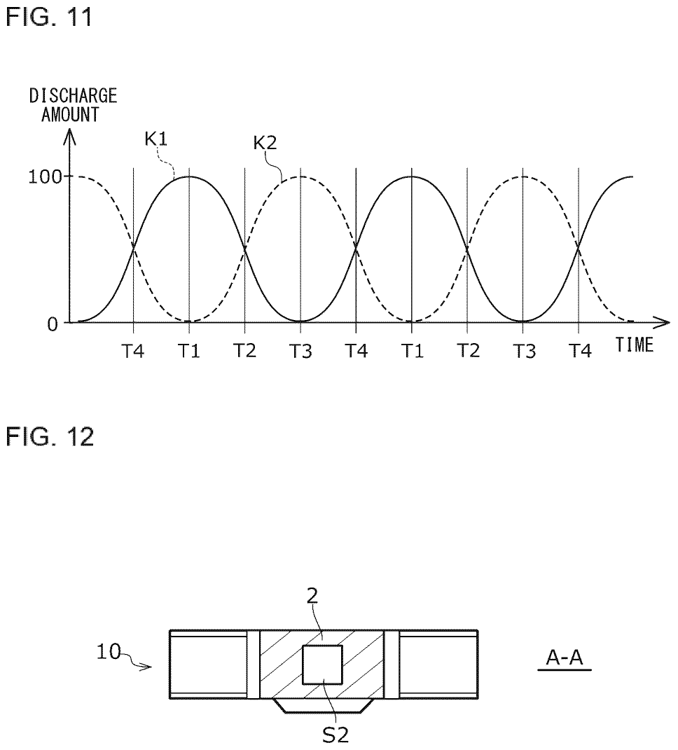

With reference to FIG. 8, FIG. 9, FIG. 10, and FIG. 11, flows of a fluid in the device 100 will be described. Each of FIG. 8, FIG. 9, and FIG. 10 schematically illustrates a flow of a fluid in the device 100.

A pulsating flow discharged through the flow path outlets 271 will be referred to as a first pulsating flow K1, and a pulsating flow discharged through the flow path outlets 272 will be referred to as a second pulsating flow K2.

FIG. 11 is a diagram that shows flow rate changes of the first pulsating flow K1 and the second pulsating flow K2. A pulsating flow may be a flow of fluid of which at least one of the flow rate and the flow velocity varies with time. In the example of FIG. 11, the first pulsating flow K1 and the second pulsating flow K2 pulsate with the same period, the second pulsating flow K2 is minimum at timing T1 when the first pulsating flow K1 is maximum, and the first pulsating flow K1 is minimum at timing T3 when the second pulsating flow K2 is maximum. Timing in the middle of the timing T1 and the timing T3, at which the flow rates of the first pulsating flow K1 and the second pulsating flow K2 are the same, will be referred to as timing T2 and timing T4. The minimum flow rate of a pulsating flow may be zero or greater than zero. The ratio of the maximum flow rate to the minimum flow rate (maximum flow rate/minimum flow rate) of a pulsating flow may be referred to as the contrast ratio of the pulsating flow.

As shown in FIG. 3, FIG. 4, FIG. 5, and FIG. 6, the wavy flow J discharged through the discharge port 2 of the fluidic oscillator 10 changes its traveling direction to the left or right depending on time. In the following, the flow of fluid will be described for each of the cases where the traveling direction of the wavy flow J is rightward, leftward, and straight ahead.

In the state of timing T1 shown in FIG. 8, the fluid J discharged through the discharge port 2 flows diagonally rightward from the branch inlet 63 of the branch flow path 6, passes through the branch outlet 61 and the transmission inlet 73, and flows into the transmission flow path 7L. The fluid flowing through the branch outlet 61 is referred to as a first fluid J1. The first fluid J1 flowing into the transmission flow path 7L is discharged as the first pulsating flow K1 through the multiple flow path outlets 271 to open space. In the example of FIG. 8, the first pulsating flow K1 is discharged to the left in the figure.

In the state of timing T3 shown in FIG. 10, the fluid J discharged through the discharge port 2 flows diagonally leftward from the branch inlet 63 of the branch flow path 6, passes through the branch outlet 62 and the transmission inlet 74, and flows into the transmission flow path 7R. The fluid J flowing through the branch outlet 62 is referred to as a second fluid J2. The second fluid J2 flowing into the transmission flow path 7R is discharged as the second pulsating flow K2 through the multiple flow path outlets 272 to open space. In the example of FIG. 10, the second pulsating flow K2 is discharged to the right in the figure.

In the state of timing T2 and timing T4 shown in FIG. 9, the fluid J discharged through the discharge port 2 flows straight ahead from the branch inlet 63 of the branch flow path 6. Therefore, the fluid J branches into the first fluid J1 and the second fluid J2 at the branch inlet 63 and flows along the paths shown in FIG. 8 and FIG. 10 simultaneously. The first fluid J1 is discharged as the first pulsating flow K1 through the multiple flow path outlets 271 to open space, and the second fluid J2 is discharged as the second pulsating flow K2 through the multiple flow path outlets 272 to open space.

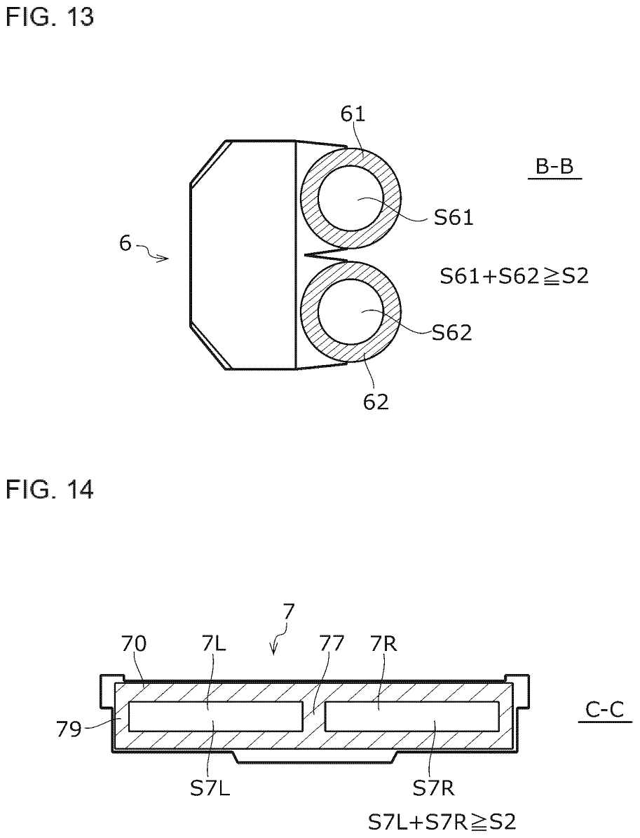

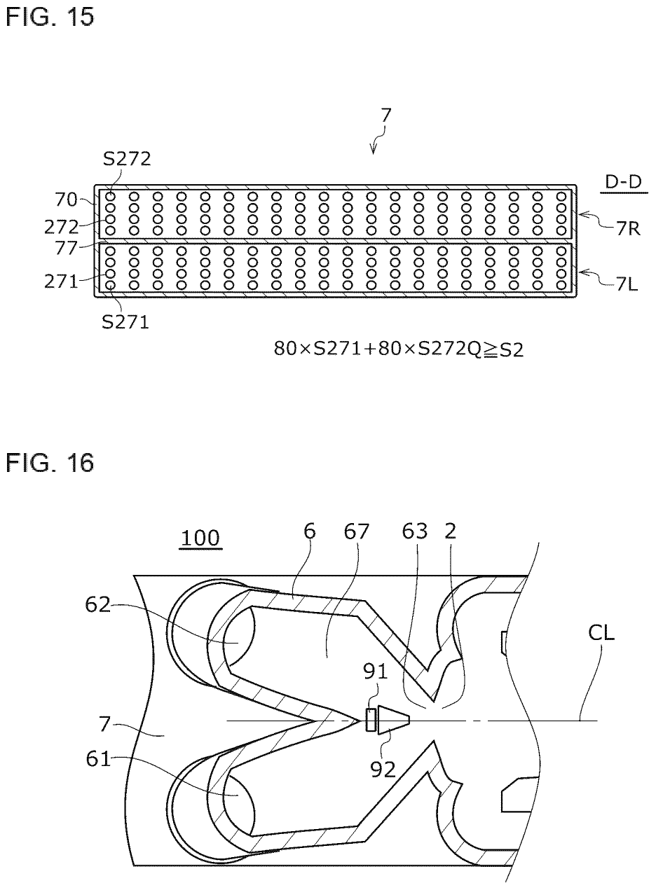

With reference to FIG. 12, FIG. 13, FIG. 14, and FIG. 15, the area of a cross section perpendicular to the flow of fluid (hereinafter, simply referred to as the “cross-sectional area”) in each fluid passage will be described. The reference sign S2 in FIG. 12 indicates the cross-sectional area of the discharge port 2 of the fluidic oscillator 10, at a cross section taken along line A-A. The reference signs S61 and S62 in FIG. 13 indicate the cross-sectional areas of the branch outlets 61 and 62, at a cross section taken along line B-B. The reference signs S7L and S7R in FIG. 14 indicate the cross-sectional areas of the transmission flow paths 7L and 7R, at a cross section taken along line C-C. The reference signs S271 and S272 in FIG. 15 indicate the cross-sectional areas of the flow path outlets 271 and 272, at a cross section taken along line D-D.

As a result of experiments conducted by the inventors of the subject application, it is suggested that, when the cross-sectional area of a fluid passage located downstream of the fluidic oscillator 10 is greater than or equal to the cross-sectional area of a downstream end (the discharge port 2) of the fluidic oscillator 10, the pulsating flows K1 and K2 with a favorable contrast ratio are likely to appear. This may be because, when the cross-sectional area of a downstream fluid passage is small, the fluid is likely to remain on the downstream side, and, when the fluid remains, the minimum flow rate of the second pulsating flow K2 at the timing T1 does not become zero, and the minimum flow rate of the first pulsating flow K1 at the timing T3 also does not become zero, resulting in a low contrast ratio. When a fluid passage branches into multiple passages, the cross-sectional area of the fluid passage can be considered as the sum of the cross-sectional areas of the branched passages. The cross-sectional area of every fluid passage located downstream of the fluidic oscillator 10 may be configured to be greater than or equal to the cross-sectional area of the downstream end of the fluidic oscillator 10.

In the device 100, the sum of the cross-sectional areas S61 and S62 of the branch outlets 61 and 62 (S61+S62) is greater than or equal to the cross-sectional area S2 of the discharge port 2 of the fluidic oscillator 10. Each of the cross-sectional areas S61 and S62 may be the cross-sectional area of a portion having the smallest cross-sectional area of the corresponding fluid passage of the branch flow path 6. In the device 100, the sum of the cross-sectional areas S7L and S7R of the internal spaces of the transmission flow paths 7 (S7L+S7R) is greater than or equal to the cross-sectional area S2 of the discharge port 2 of the fluidic oscillator 10. Each of the cross-sectional areas S7L and S7R may be the cross-sectional area of a portion having the smallest cross-sectional area of the corresponding one of the transmission flow paths 7L and 7R of the transmission flow paths 7. In the device 100, the sum of the cross-sectional areas S271 and S272 of the multiple flow path outlets 271 and 272 (80×S271+80×S272) is greater than or equal to the cross-sectional area S2 of the discharge port 2 of the fluidic oscillator 10. Each of the cross-sectional areas S271 and S272 may be the cross-sectional area of a portion having the smallest cross-sectional area of an outlet of the multiple flow path outlets 271 and 272.

The sum of the cross-sectional areas S61 and S62 is preferably 1.2 times or more the cross-sectional area S2 of the discharge port 2. The sum of the cross-sectional areas S7L and S7R is preferably 1.2 times or more the cross-sectional area S2 of the discharge port 2. The sum of the cross-sectional areas S271 and S272 is preferably 1.2 times or more the cross-sectional area S2 of the discharge port 2. When these area ratios are 1.2 times or more, the pulsating flows K1 and K2 with a favorable contrast ratio are likely to appear, so that a favorable cleaning effect, a favorable massage effect, and the like can be obtained.

With reference to FIG. 16, an intake opening 91 of the device 100 will be described. The greater the discharge amount from the multiple flow path outlets 271 and 272, the stronger the cleaning power or the massage sensation given. As a result of repeated trials and studies, the inventors have found that the discharge amount from the flow path outlets 271 and 272 can be increased by providing, on the downstream side of the fluidic oscillator, an intake hole through which a fluid can be drawn in from the outside. Therefore, the device 100 according to the first embodiment includes the intake opening 91 that is located downstream of the discharge port 2 of the fluidic oscillator 10 and through which a fluid can be drawn in from open space. In the example of FIG. 16, the intake opening 91 is a downward opening provided in a bottom part 67 of the branch flow path 6, at a position downstream of the branch inlet 63 and before the branch into the branch outlets 61 and 62. The shape, size, position, and the like of the intake opening 91 may be determined through simulations or the like, based on the desired discharge amount.

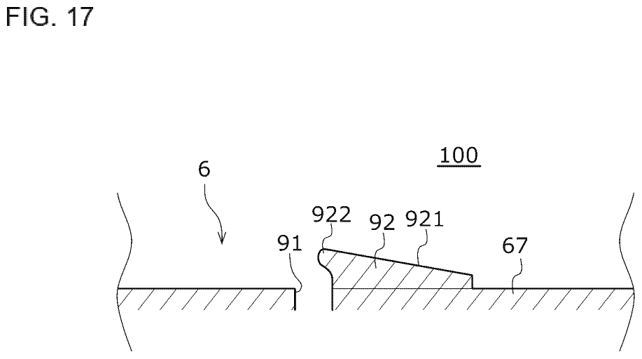

With reference to FIG. 16 and FIG. 17, an example of a protrusion 92 of the device 100 will be described. FIG. 17 shows a longitudinal cross section along a center line CL of each of the intake opening 91 and the protrusion 92. As a result of experiments, the inventors have found that, when the intake opening 91 is provided, if the flow rate is higher, the wavy flow J is more likely to flow back through the intake opening 91 to the outside. From the viewpoint of reducing backflow, it is desirable to keep the fluid away from the intake opening 91. Therefore, the device 100 according to the first embodiment includes the protrusion 92 protruding in a fluid passage and located near the intake opening 91 on the upstream side thereof.

In the example of FIG. 17, the protrusion 92 is provided, in the bottom part 67, near the intake opening 91 on the upstream side thereof and has a substantial trapezoidal shape in plan view, of which the width in the left and right directions gradually increases from the upstream side toward the downstream side. In this example, an upper surface of the protrusion 92 includes an inclined surface 921 of which the height from the bottom part 67 gradually increases from the upstream side toward the downstream side. The protrusion 92 having a substantial trapezoidal shape and including the inclined surface 921 can suppress the increase in flow path resistance. From the viewpoint of reducing backflow, an overhang part 922 projecting like an eave from the downstream side of the protrusion 92 may be provided above the intake opening 91.

There will now be described the features of the housing equipment device 100 according to the first embodiment.

A housing equipment device 100 includes a fluidic oscillator 10, a branch flow path 6 connected to a discharge port 2 of the fluidic oscillator 10 and having multiple branch outlets 61 and 62, and multiple flow path outlets 271 and 272 that each are connected to one of the multiple branch outlets 61 and 62 and through which a fluid from each of the branch outlets is discharged to open space. Pulsating flows K1 and K2 are discharged through the flow path outlets 271 and 272, and the sum of the cross-sectional areas of the narrowest portions in fluid passages located downstream of the discharge port 2 of the fluidic oscillator 10 is greater than or equal to the cross-sectional area of the discharge port 2 of the fluidic oscillator 10.

With this configuration, since the multiple pulsating flows K1 and K2 can be discharged using a single fluidic oscillator 10, it is advantageous for downsizing compared to the case where multiple fluidic oscillators are provided. Since no moving part is provided, the likelihood of causing a failure due to wear of a moving part or dust caught in a moving part can be reduced. When the device 100 is applied to the cleaning use, with the multiple pulsating flows K1 and K2, a favorable cleaning effect can be obtained. When the device 100 is applied to the use of discharging toward a human body, the multiple pulsating flows K1 and K2 can provide a favorable massage sensation.

In the housing equipment device 100, the sum of the cross-sectional areas of the branch outlets 61 and 62 is greater than or equal to the cross-sectional area of the discharge port 2 of the fluidic oscillator 10. In this case, the pulsating flows K1 and K2 with a favorable contrast ratio can be easily achieved.

In the housing equipment device 100, the sum of the cross-sectional areas of the flow path outlets 271 and 272 is greater than or equal to the cross-sectional area of the discharge port 2 of the fluidic oscillator 10. In this case, the pulsating flows K1 and K2 with a favorable contrast ratio can be easily achieved.

The housing equipment device 100 includes multiple transmission flow paths 7L and 7R that are connected respectively to the multiple branch outlets 61 and 62 and that transmit a fluid from each of the branch outlets to the flow path outlets 271 and 272. The sum of the cross-sectional areas of the multiple transmission flow paths 7L and 7R is greater than or equal to the cross-sectional area of the discharge port 2 of the fluidic oscillator 10. In this case, the pulsating flows K1 and K2 with a favorable contrast ratio can be easily achieved. With the transmission flow paths 7L and 7R, the distance between the flow path outlets 271 and 272 and the fluidic oscillator 10 can be separated, which enables mounting of the housing equipment device 100 without impairing the ease of use and aesthetics thereof.

The device 100 includes the intake opening 91 that is located downstream of the discharge port 2 of the fluidic oscillator 10 and through which a fluid can be drawn in from open space. In this case, since a fluid can be drawn in from the outside, the discharge amount from the multiple flow path outlets 271 and 272 can be increased.

The housing equipment device 100 includes the protrusion 92 protruding in a fluid passage and located near the intake opening 91 on the upstream side thereof. In this case, the fluid can be kept away from the intake opening 91, so that backflow from the intake opening 91 can be reduced.

The above is a description of the first embodiment.

In the following, modifications of the first embodiment will be described. In the drawings and description of the modifications, like reference characters denote like or corresponding constituting elements and members in the first embodiment. Repetitive description already provided in the first embodiment will be omitted as appropriate, and configurations different from those in the first embodiment will be intensively described.

Although the first embodiment describes an example in which the flow path outlets 271 and the flow path outlets 272 include the same number of outlets of the same shape arranged symmetrically, the application is not limited thereto. These outlets may be arranged asymmetrically, may have shapes different from each other, or may be different in number from each other.

Although the first embodiment describes an example of branching into two in the branch flow path 6, the application is not limited thereto. The branch flow path may branch the fluid into three or more. In this case, the internal space of the transmission flow path is divided into the same number as the branches, and branch flows are introduced respectively into the divided internal spaces, so that three or more pulsating flows can be discharged.

Although the first embodiment describes an example in which the branch flow path 6 is bent 90 degrees, the application is not limited thereto. The branch flow path may not be bent or may be bent at an angle different from 90 degrees.

Although the first embodiment describes an example in which the intake opening 91 and the protrusion 92 are provided in the bottom part 67 of the branch flow path 6, the application is not limited thereto. For example, the intake opening and the protrusion may be provided in a ceiling part, a sidewall part, or the like of the branch flow path.

Although the first embodiment describes an example in which a feedback path is a path through which part of the main fluid M is fed back from a downstream part 132 to the upstream part 131 in a main path 13, the application is not limited thereto. For example, a feedback path may be a path through which part of the fluid is fed back from a downstream part of the branch flow path to the vicinity of the discharge port 2. As long as a wavy flow flows down through the discharge port 2, whether or not a feedback path is provided or the connection position thereof is not limited. The configuration of the fluidic oscillator is not limited to that of the fluidic oscillator 10, and any configuration that can function as a fluidic oscillator based on a publicly-known principle can be adopted.

The background of the second disclosure will be described. For example, Japanese Unexamined Patent Application Publication No. 2008-274634 describes a water discharge device capable of switching the discharge mode of hot water or water and adjusting the flow rate. This device is equipped with a switching member that alternately switches, when a button is pressed, the discharge mode of hot water or water discharged, between discharge through a first water hole and discharge through a second water hole. The switching member includes a flow rate adjusting member that adjusts the flow rate of hot water or water discharged through each water hole, and, by linking the flow rate adjusting member with the button, the switching of the discharge mode of hot water or water and the flow rate adjustment can be performed by operation of the button.

The inventors of the subject application examined the mechanism for discharging a discharge flow through a discharge port while switching between discharge flows of different modes and obtained the following new recognition. When the device described in Japanese Unexamined Patent Application Publication No. 2008-274634 is used, since the jetting mode of hot water or water discharged is switched by pressing a button to make the switching member advance or recede, a space for the advance and receding of the switching member is required. Also, since this device includes a holding device for the advance or receding state to facilitate the operation, an additional space is further required. Thus, since these spaces are necessary, this device is disadvantageous for the overall downsizing of the device.

A purpose of the second disclosure is to provide a housing equipment device that is advantageous for downsizing and that can discharge a discharge flow while switching between discharge flows of different modes.

In order to solve the aforementioned issue, a housing equipment device according to one embodiment of the second disclosure includes a flow path having an inlet port and a single discharge port, and a discharge mode switching unit that switches between a first discharge mode of discharging a straight flow through the discharge port and a second discharge mode of discharging a wavy flow through the discharge port. The discharge mode switching unit includes a switching member that is part of a sidewall of the flow path and that can switch between the first discharge mode and the second discharge mode by rotating with respect to the flow path body.

### Second Embodiment

In terms of usability and design, it is desirable to downsize a housing equipment device, and such downsizing can expand the applicable range of the device. With a device that makes the switching member advance and recede, such as the device described in Japanese Unexamined Patent Application Publication No. 2008-274634, when a space related to the switching member, such as a space for the advance and receding of the switching member, is provided, the device becomes larger in relation to the space, which is disadvantageous for downsizing. This device cannot discharge a flow through a single outlet while switching between flows of multiple modes and includes first flow path and water hole for a first jetting mode and second flow path and water hole for a second jetting mode separately. Thus, this device has disadvantageous aspects of being larger and more complex. The second disclosure is made based on these findings and, in the following, the technology of the second disclosure will be described with reference to the second embodiment.

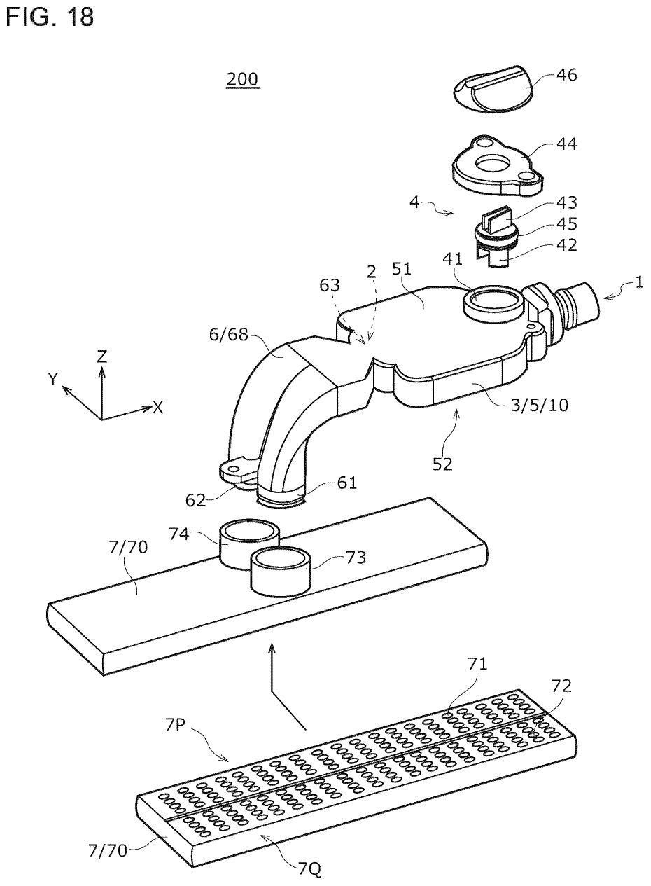

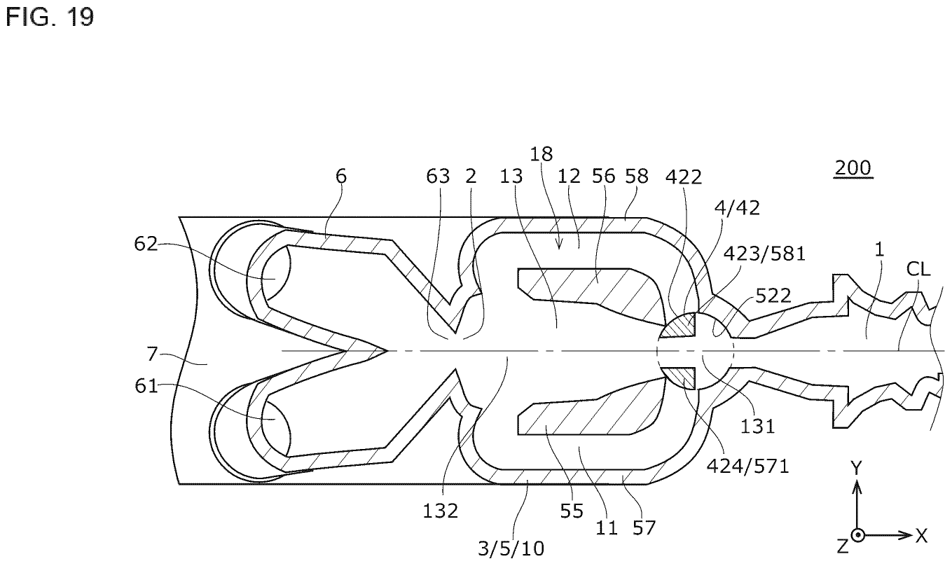

There will now be described devised features of a housing equipment device 200 according to the second embodiment. FIG. 18 and FIG. 19 are now referred to. The second embodiment of the second disclosure is the housing equipment device 200 that can be used as a shower that discharges hot water and water. Hereinafter, the housing equipment device 200 may also be referred to as the device 200. The device 200 includes a flow path 3, a discharge mode switching unit 4, a branch flow path 6, and a transmission flow path 7. The flow path 3 includes a flow path body 5 having an inlet port 1 and a single discharge port 2. The discharge mode switching unit 4 is a mechanism for switching between a first discharge mode of discharging a straight flow F through the discharge port 2 and a second discharge mode of radially discharging a wavy flow J through the discharge port 2. The discharge mode switching unit 4 includes a switching member 42 that is part of a sidewall of the flow path 3 and that can switch between the first discharge mode and the second discharge mode by rotating with respect to the flow path body 5. In the description of the second embodiment, a flow that jets out from a small hole to open space will be referred to as a “jet flow”, a fluctuating jet flow will be referred to as a “fluctuating flow”, and a pulsating jet flow will be referred to as a “pulsating flow”. In concept, the jet flow includes the fluctuating flow and the pulsating flow.

For the sake of convenience, on a plane as shown in the figure, front and rear directions on the plane along the discharge direction of the flow path 3 will be referred to as X directions, left and right directions perpendicular to the front and rear directions on the plane will be referred to as Y directions, and vertical up and down directions will be referred to as Z directions. In the X directions, the direction of the arrow will be referred to as “rear” or “rearward”, and the direction opposite to the arrow direction will be referred to as “front” or “frontward”. In the Y directions, the direction of the arrow will be referred to as “right” or “rightward”, and the direction opposite to the arrow direction will be referred to as “left” or “leftward”. An X direction, a Y direction, and a Z direction are perpendicular to each other. This is not limited to the case where they are strictly perpendicular, but also includes the case where they are nearly perpendicular. Such description regarding directions does not limit the posture of the device 200 during its use, and the device 200 may be used in any posture depending on the application.

The configuration of the flow path 3 will be described. In the flow path 3, a fluid supplied from the outside to the inlet port 1 flows through the flow path body 5 and is discharged through the discharge port 2. As shown in FIG. 18 and FIG. 19, the flow path body 5 is a box member that surrounds a path space 18, which serves as a path for the fluid. The flow path body 5 includes a ceiling part 51 and a bottom part 52 that sandwich the path space 18, intermediate walls 55 and 56 for dividing the path space 18 into three parts in the left and right directions, and outer walls 57 and 58 that surround the path space 18 from the sides. The inlet port 1 is provided at an upstream end of the flow path body 5 so as to supply the fluid to the path space 18. The discharge port 2 is provided at a downstream end of the flow path body 5 so as to discharge the fluid from the path space 18. The intermediate walls 55 and 56 include a first intermediate wall 55 and a second intermediate wall 56 provided symmetrically across a bisector with respect to the left and right directions (hereinafter, referred to as the center line CL) of the flow path 3. The center in the left and right directions of each of the inlet port 1 and the discharge port 2 is positioned on the center line CL.

The flow path 3 constitutes the fluidic oscillator 10 when an oscillation condition is satisfied. In the following, when a function as a fluidic oscillator is described, the flow path 3 may be referred to as the fluidic oscillator 10. When the oscillation condition is satisfied, the fluidic oscillator 10 discharges the wavy flow J through the discharge port 2, and, when the oscillation condition is not satisfied, the fluidic oscillator 10 discharges the straight flow F through the discharge port 2. With regard to the wavy flow J, the direction of discharge from the discharge port 2 periodically changes. Because of its discharge mode, the wavy flow J may be sometimes referred to as a motion flow, an oscillating flow, or the like. The straight flow F is a flow of which the direction of discharge from the discharge port 2 is substantially constant and includes a flow parallel to the center line CL and a flow inclined with respect to the center line CL. The straight flow F may be sometimes referred to as a non-motion flow, a non-oscillating flow, or the like. As the fluidic oscillator, a fluidic oscillator based on a publicly known principle can be employed, such as one that generates a Karman vortex to induce a wavy motion jet, or one that uses the Coanda effect to induce a wavy motion jet. Since the fluidic oscillator itself is publicly known, detailed description therefor will be omitted.

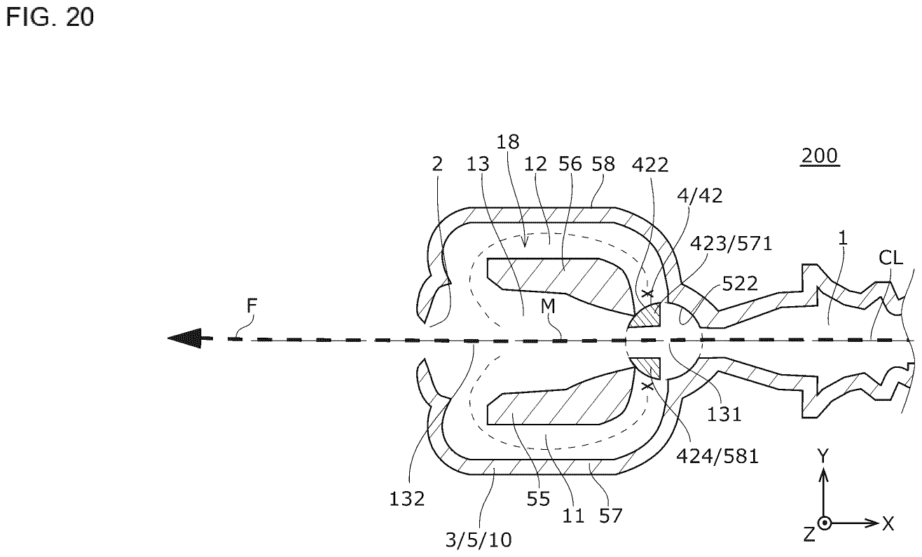

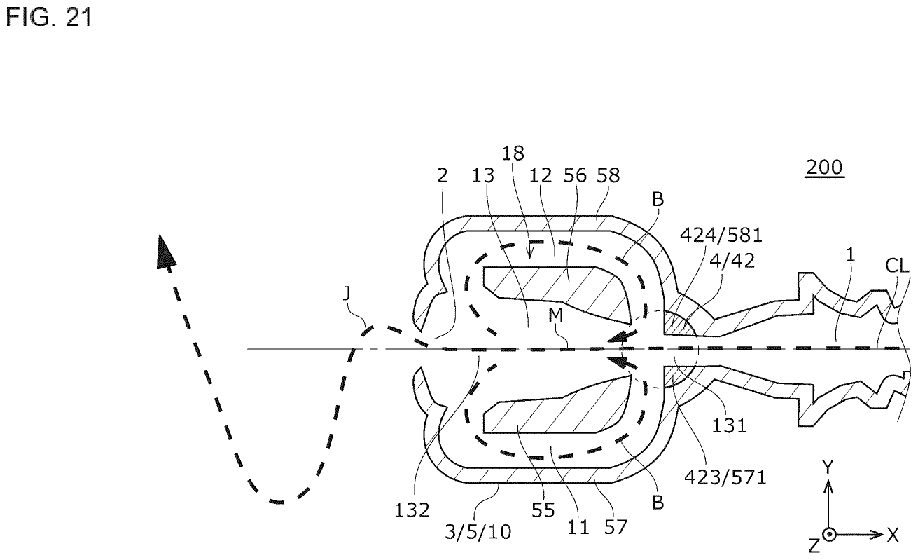

FIG. 20 and FIG. 21 are also referred to. The fluidic oscillator 10 according to the present embodiment includes a main path 13, a first feedback path 11, and a second feedback path 12. The first feedback path 11 and the second feedback path 12 may be collectively referred to as feedback paths. The main path 13 is a path extending along the center line CL and includes a portion formed between the first intermediate wall 55 and the second intermediate wall 56 and a portion formed between the outer walls 57 and 58. In the main path 13, a fluid supplied through the inlet port 1 flows toward the discharge port 2. Hereinafter, as shown in FIG. 20 and FIG. 21, a fluid flowing through the main path 13 will be referred to as a “main fluid M”.

The first feedback path 11 is a path extending in a substantially X direction to the left of the main path 13. The first feedback path 11 is formed between the first intermediate wall 55 and the first outer wall 57. The second feedback path 12 is a path extending in a substantially X direction to the right of the main path 13. The second feedback path 12 is formed between the second intermediate wall 56 and the second outer wall 58. The first feedback path 11 and the second feedback path 12 can be configured symmetrically. The feedback paths are paths through which part of the main fluid M is fed back from a downstream part 132 to an upstream part 131 in the main path 13. Hereinafter, a fluid flowing through a feedback path will be referred to as a “feedback fluid B”.

The configuration of the fluidic oscillator 10 in the present embodiment is the same as that of the fluidic oscillator 10 in the first embodiment, and repetitive description will be omitted. Also, the operating principle of the fluidic oscillator 10 in the present embodiment is the same as that of the fluidic oscillator 10 in the first embodiment, and FIG. 3, FIG. 4, FIG. 5, FIG. 6 and the description thereof are applicable.

The fluidic oscillator 10 can stop the oscillation by making the flow rate of a feedback fluid B smaller than a threshold. For this purpose, a feedback path may be blocked, or a feedback path may be narrowed. The fluidic oscillator 10 can stop the oscillation by breaking the symmetry of at least one of the main path 13 or the feedback paths. In the first discharge mode shown in FIG. 20, the fluidic oscillator 10 rotates the switching member 42 to narrow the feedback paths and stop the oscillation. In the second discharge mode shown in FIG. 21, the fluidic oscillator 10 rotates the switching member 42 to widen the feedback paths and induce oscillation.

The discharge mode switching unit 4 will be described. The discharge mode switching unit 4 can switch between the first discharge mode and the second discharge mode. As shown in FIG. 18, the discharge mode switching unit 4 includes an opening support 41, the switching member 42, a connection shaft 43, an attachment 44, an O-ring 45, and an operating part 46. The opening support 41 is an annular portion surrounding a circular opening formed in the ceiling part 51, above the upstream part 131 of the main path 13. The opening support 41 may be formed integrally with the ceiling part 51 or may be formed separately from the ceiling part 51.

The switching member 42 has a surface 422 in contact with the flow path body 5, in a circumferential surface surrounding a rotational axis line of the switching member 42. As shown in FIG. 19 and FIG. 20, for smooth rotation with respect to the flow path body 5, the surface 422 is desirably a surface along an arc that is coaxial with the rotational axis line of the switching member 42. In this regard, the surface 422 can include at least one of a convex surface of partial cone shape or a convex surface of partial cylinder shape. When the surface 422 is a convex surface of partial cone shape, a surface 522 of the flow path body 5 that is in contact with the switching member 42 may be a concave surface of partial cone shape. When the surface 422 is a convex surface of partial cylinder shape, the surface 522 may be a concave surface of partial cylinder shape.

In the example of FIG. 19, the surface 422 includes a convex surface of partial cylinder shape, and the surface 522 includes a concave surface of partial cylinder shape. In the example of FIG. 19, the switching member 42 includes two partial cylinder parts 423 and 424, which each are a column with a substantial quadrant as the base. In the state of FIG. 19, the two partial cylinder parts 423 and 424 are arranged symmetrically across the center line CL. The partial cylinder parts 423 and 424 each have a three-dimensional shape that can be formed by moving a substantial quadrant up and down. The switching member 42 has functions to narrow and widen at least one of the main path 13 and the feedback paths by rotating around the rotational axis line extending vertically.

As shown in FIG. 18, the connection shaft 43 is a member that is fixed to the switching member 42 and extends upward from the switching member 42, and the O-ring 45 is attached to the outer circumference of the connection shaft 43. The connection shaft 43 is connected to the operating part 46 by being fitted into an insertion hole provided on a lower surface of the operating part 46. The attachment 44 is attached to the opening support 41 by a fixture, such as a screw, and supports the switching member 42, the connection shaft 43, and the operating part 46 so that they are rotatable. The operating part 46 is an operation knob used by a user to input an operation to rotate the switching member 42. The operating part 46 is connected to the connection shaft 43, and, by rotating the operating part 46, the connection shaft 43 and the switching member 42 rotate together.

With reference to FIG. 18 and FIG. 19, the branch flow path 6 will be described. The branch flow path 6 includes a branch inlet 63 connected to the discharge port 2, and multiple branch outlets 61 and 62. The branch inlet 63 is provided at an upstream end of a branch flow path body 68, and the branch outlets 61 and 62 are provided at a downstream end of the branch flow path body 68. In the example of FIG. 18, the fluid that flows in the front direction from the branch inlet 63 branches in two directions in the branch flow path 6, is bent approximately 90 degrees, and is discharged downward through each of the branch outlets 61 and 62.

With reference to FIG. 18, the transmission flow path 7 will be described. The transmission flow path 7 includes transmission inlets 73 and 74 connected to the branch outlets 61 and 62, and multiple jetting ports 71 and 72 communicating with open space. The transmission inlets 73 and 74 are pipe-shaped portions protruding upward from a ceiling part of a transmission flow path body 70 and provided in the middle of the ceiling part in a front or rear direction. The transmission flow path body 70 is a vertically flattened box with its long side directions in the front and rear directions and shows a rectangular shape in plan view. The jetting ports 71 and 72 are multiple holes provided in a bottom part of the transmission flow path body 70 and arranged in a matrix in the front, rear, left, and right directions. As an example, the jetting ports 71 and 72 may have shapes and arrangement suitable for water sprinkling, and the transmission flow path 7 may be used as a sprinkler plate.

The internal space of the transmission flow path body 70 is partitioned into two internal spaces 7P and 7Q on the left and right by a partition wall (not illustrated). The fluid from the transmission inlet 73 flows into the internal space 7P of the transmission flow path body 70 and is discharged through the jetting ports 71. The fluid from the transmission inlet 74 flows into the internal space 7Q of the transmission flow path body 70 and is discharged through the jetting ports 72. In the transmission flow path 7, the straight flow F jets out from the multiple jetting ports 71 and 72 in the first discharge mode, and the wavy flow J, of which the traveling direction varies with time, jets out from the multiple jetting ports 71 and 72 in the second discharge mode.

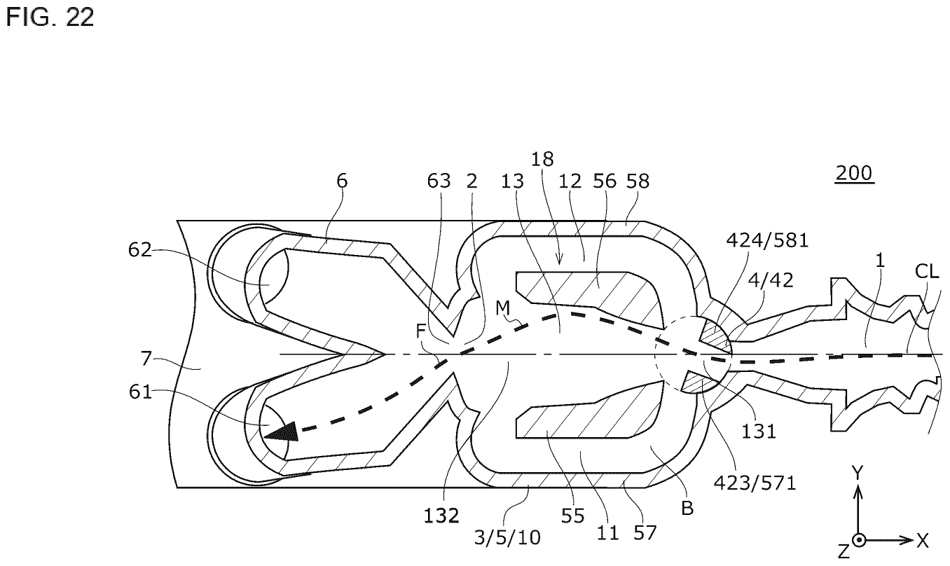

With reference also to FIG. 22, the switching member 42 will be further described. In FIG. 22, illustration of the feedback flows is omitted. In the example of FIG. 22, the switching member 42 includes a part of each of two sidewalls, facing each other, of the flow path 3. The two sidewalls are exemplified by the outer walls 57 and 58, and parts of the respective two sidewalls are exemplified by portions 571 and 581 of the outer walls 57 and 58. That is, the portion 571 corresponds to the partial cylinder part 423, and the portion 581 corresponds to the partial cylinder part 424. The portions 571 and 581 are neck-like portions at the downstream end of a path extending downstream from the inlet port 1 along the center line CL.

In the state of FIG. 22, the two portions 571 and 581 are rotated about 30 degrees clockwise from the state of FIG. 21. In this state, since the left-right symmetry of the main path 13 is broken, the fluidic oscillator 10 stops oscillation and discharges the straight flow F through the discharge port 2. Thus, by rotating the two portions 571 and 581, the direction of the straight flow F in the first discharge mode can be easily changed. When the branch flow path 6 is connected, by rotating the two portions 571 and 581 to change the direction of the straight flow F, the fluid can be selectively supplied to one of the branch outlets 61 and 62 or the other. As shown in FIG. 22, when the two portions 571 and 581 are rotated clockwise, the fluid can be supplied mainly to the branch outlet 61. When the two portions 571 and 581 are rotated in the opposite direction, the fluid can be supplied mainly to the branch outlet 62. The shapes of the portions 571 and 581 and the rotational positions of the portions 571 and 581 can be set through experiments in terms of achieving the desired wavy flow J and straight flow F.

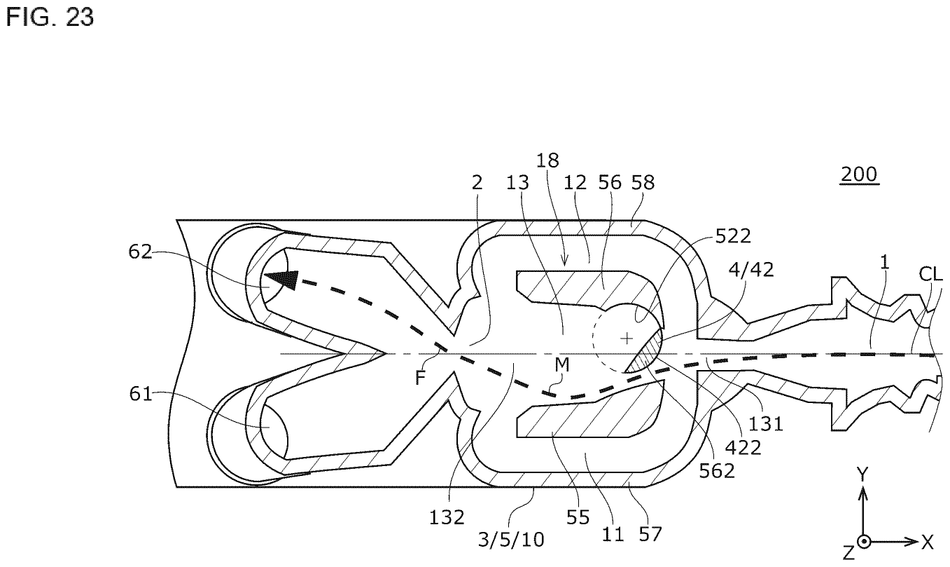

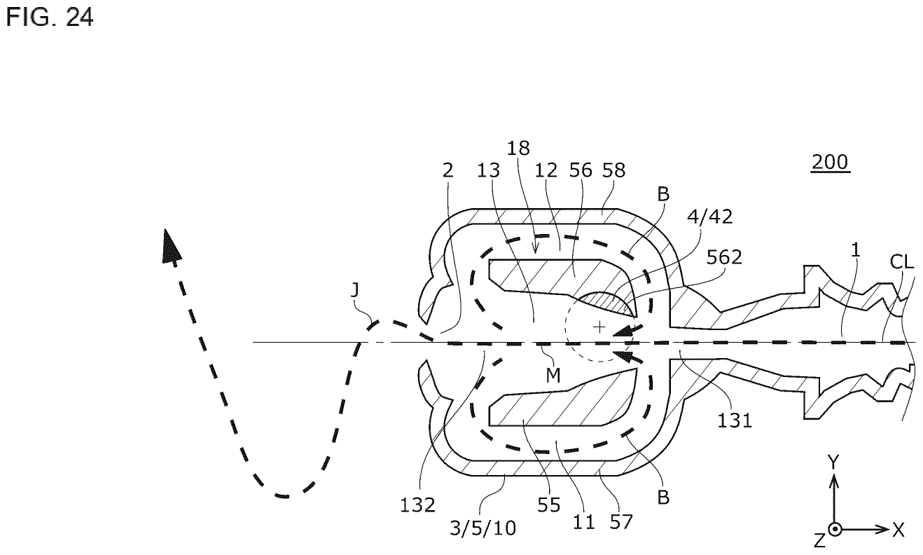

With reference to FIG. 23 and FIG. 24, another example of the switching member 42 will be described. In FIG. 23, illustration of the feedback flows is omitted. Although the aforementioned example describes an example in which the switching member 42 includes a part of each of two sidewalls, the application is not limited thereto. As shown in FIG. 23 and FIG. 24, the switching member 42 may include a part of one of two sidewalls facing each other of the flow path 3. The two sidewalls are exemplified by the intermediate walls 55 and 56, and a part of one of the two sidewalls is exemplified by a portion 562 of the intermediate wall 56 that faces the main path 13. In other words, the switching member 42 is the portion 562 of the intermediate wall 56 that faces the main path 13 and is a column with a closed arc as the base (a three-dimensional shape formed by moving the closed arc up and down).

Hereinafter, a state in which the portion 562 has been rotated with respect to the intermediate wall 56, as shown in FIG. 23, will be referred to as a rotated state, and a state in which the portion 562 has not been rotated with respect to the intermediate wall 56, as shown in FIG. 24, will be referred to as a non-rotated state.

The flow path 3 in FIG. 23 and FIG. 24 will be described as the fluidic oscillator 10. As shown in FIG. 24, in the non-rotated state, the main path 13 has symmetry. Therefore, the fluidic oscillator 10 oscillates with the same functional mechanism as in the example of FIG. 21 and discharges the wavy flow J through the discharge port 2. Meanwhile, as shown in FIG. 23, in the rotated state, the portion 562 is placed in a state where it has been rotated about 120 degrees clockwise from the non-rotated state. In this state, since the left-right symmetry of the main path 13 is broken, the fluidic oscillator 10 stops oscillation and discharges the straight flow F through the discharge port 2. In this example, the fluid can be supplied mainly to the branch outlet 62. When the portion 562 is rotated in the opposite direction, the fluid can be supplied mainly to the branch outlet 61. The shape of the portion 562 and the rotational position of the portion 562 can be set through experiments in terms of achieving the desired wavy flow J and straight flow F.

There will now be described the features of the housing equipment device 200 according to the second embodiment.

The housing equipment device 200 includes a flow path 3 having an inlet port 1 and a single discharge port 2, and a discharge mode switching unit 4 that switches between a first discharge mode of discharging a straight flow F through the discharge port 2 and a second discharge mode of discharging a wavy flow J through the discharge port 2. The discharge mode switching unit 4 includes a switching member 42 that is part of a sidewall of the flow path 3 and that can switch between the first discharge mode and the second discharge mode by rotating with respect to the flow path body 5.

With this configuration, since the discharge mode can be switched by rotating the switching member 42, a space for advance and receding of a member need not be provided, which is advantageous for downsizing. Also, since a fluid of multiple discharge modes can be discharged through a single discharge port 2, it is advantageous for downsizing compared to a configuration in which multiple discharge ports are provided.

In the housing equipment device 200, in a circumferential surface of the switching member 42 surrounding a rotational axis line of the switching member 42, a surface 422 in contact with the flow path body 5 includes at least one of a convex surface of partial cone shape or a convex surface of partial cylinder shape. A surface 522 of the flow path body 5 in contact with the switching member 42 includes at least one of a concave surface of partial cone shape or a concave surface of partial cylinder shape. In this case, the switching member 42 can rotate smoothly with respect to the flow path body 5. Also, the gap between the switching member 42 and a portion of the flow path body 5 facing the switching member 42 can be made smaller.

The housing equipment device 200 further includes a branch flow path 6 connected to the discharge port 2 and having multiple branch outlets 61 and 62, and a transmission flow path 7 connected to the branch outlets 61 and 62 and having multiple jetting ports 71 and 72 communicating with open space. In the transmission flow path 7, a straight flow jets out through each of the multiple jetting ports 71 and 72 in the first discharge mode, and a jet flow, of which at least one of the flow rate or the traveling direction varies with time, flows down through each of the multiple jetting ports 71 and 72 in the second discharge mode. In this case, the mode of jetting from the jetting ports 71 and 72 can be switched. In the case of discharging in the first discharge mode, since there is no change in the flow rate supplied to the transmission flow path 7, a jetting flow with no temporal change can be discharged. In the case of discharging in the second discharge mode, since the flow rate supplied to the transmission flow path 7 changes due to the wavy flow J, a jetting flow with a temporal change can be discharged. With the transmission flow path 7, the distance between the jetting ports 71 and 72 and the fluidic oscillator 10 can be separated, which enables mounting of the housing equipment device 200 without impairing the ease of use and aesthetics thereof.

In the housing equipment device 200, the switching member 42 includes a part of each of two sidewalls, facing each other, of the flow path 3. In this case, it functions as a fluidic oscillator in the second discharge mode (wavy flow J) and, by rotating the switching member 42 from that state, the mode can be switched to the first discharge mode (straight flow F). By rotating the two surfaces facing each other, the direction of the straight flow F in the first discharge mode can be easily changed. When the branch flow path 6 is connected, the fluid can be selectively supplied to one of the branch outlets 61 and 62 or the other.

In the housing equipment device 200, the switching member 42 may be configured to include a part of one of two sidewalls facing each other of the flow path 3. In this case, in the first discharge mode, one side with respect to the center line CL passing through the discharge port 2 is blocked or widened, so that the flow path 3 can be made asymmetrical. As a result, the discharge direction of the straight flow F can be inclined with respect to the center line CL. When the branch flow path 6 is connected, the fluid can be selectively supplied to the branch outlets 61 and 62 provided in the branch flow path 6.

The above is a description of the second embodiment.

In the following, modifications of the second embodiment will be described. In the drawings and description of the modifications, like reference characters denote like or corresponding constituting elements and members in the second embodiment. Repetitive description already provided in the second embodiment will be omitted as appropriate, and configurations different from those in the second embodiment will be intensively described.

Although the second embodiment describes an example in which parts of respective two sidewalls, facing each other, of the flow path 3 are the portions 571 and 581 of the outer walls 57 and 58, the application is not limited thereto. For example, the two sidewalls may be the intermediate walls 55 and 56.

Although the second embodiment describes an example in which the switching member 42 is provided in the main path 13, the application is not limited thereto. For example, the switching member may be provided in a feedback path. In this case, the switching member may be a part of at least one of two sidewalls, facing each other, of an intermediate wall and an outer wall, which face the feedback path.

Although the second embodiment describes an example of branching into two in the branch flow path 6, the application is not limited thereto. The branch flow path may branch the fluid into three or more. Although the aforementioned embodiments describe examples in which the branch flow path 6 is bent 90 degrees, the application is not limited thereto. The branch flow path may not be bent or may be bent at an angle different from 90 degrees.

Although the second embodiment describes an example in which the switching member 42 rotates by rotating the operating part 46, the application is not limited thereto. The operating part may be configured as a button, and the switching member may be configured to rotate when the operating part is pressed down.

Although the second embodiment describes an example in which a feedback path is a path through which part of the main fluid M is fed back from a downstream part 132 to the upstream part 131 in a main path 13, the application is not limited thereto. For example, a feedback path may be a path through which part of the fluid is fed back from a downstream part of the branch flow path to the vicinity of the discharge port 2. As long as a wavy flow flows down through the discharge port 2, whether or not a feedback path is provided or the connection position thereof is not limited. The configuration of the fluidic oscillator is not limited to that of the fluidic oscillator 10, and any configuration that can function as a fluidic oscillator based on a publicly known principle can be adopted.

Although the second embodiment describes an example in which the jetting ports 71 and 72 have shapes and arrangement suitable for water sprinkling, the application is not limited thereto. For example, the jetting ports 71 and 72 may be provided such that flows merge and jet out. In this case, the housing equipment device 200 can jet out a fluctuating flow in the second discharge mode.

The first embodiment, the second embodiment, and modifications have been described. In understanding the technical ideas abstracted from the first embodiment, second embodiment, and modifications, the technical ideas should not be interpreted as limited to the contents of the first embodiment, second embodiment, and modifications. Each of the aforementioned first embodiment, second embodiment, and modifications merely describes a specific example, and various design modifications, including changes, addition, and deletion of constituting elements, may be made thereto. In the first and second embodiments, matters to which design modifications may be made are emphasized with the expression of “embodiment”. However, design modifications may also be made to matters without such expression. Also, the hatching provided on the cross sections in the drawings does not limit the materials of the objects with the hatching.

Optional combinations of constituting elements included in the first embodiment, second embodiment, and modifications are also effective as aspects of the technical ideas abstracted from the embodiments and modifications. For example, with one of the first embodiment, second embodiment, and modifications, an arbitrary matter described in another embodiment may be combined. Also, with a modification, an arbitrary matter described in the first embodiment, second embodiment, or another modification may be combined. For example, with the housing equipment device 100 shown in FIG. 1, the discharge mode switching unit 4 in the second embodiment may be combined.

Embodiments and modifications of the first disclosure and the second disclosure have been described. Optional combinations of the abovementioned constituting elements are also effective. For example, with the embodiment or a modification of the first disclosure, an arbitrary matter described in the embodiment or modifications of the second disclosure may be combined. Similarly, with the embodiment or a modification of the second disclosure, an arbitrary matter described in the embodiment or modifications of the first disclosure may be combined.

1. A housing equipment device, comprising:
a fluidic oscillator;
a branch flow path connected to a discharge port of the fluidic oscillator and having a plurality of branch outlets; and
a plurality of flow path outlets that each are connected to one of the plurality of branch outlets and through which a fluid from each of the branch outlets is discharged to open space,
wherein pulsating flows are discharged through the flow path outlets, and
wherein a sum of cross-sectional areas of the narrowest portions in fluid passages located downstream of the discharge port of the fluidic oscillator is greater than or equal to a cross-sectional area of the discharge port of the fluidic oscillator.

2. The housing equipment device of claim 1, wherein a sum of cross-sectional areas of the branch outlets is greater than or equal to the cross-sectional area of the discharge port of the fluidic oscillator.

3. The housing equipment device of claim 1, wherein a sum of cross-sectional areas of the flow path outlets is greater than or equal to the cross-sectional area of the discharge port of the fluidic oscillator.

4. The housing equipment device of claim 1, further comprising a plurality of transmission flow paths that are connected respectively to the plurality of branch outlets and that transmit a fluid from each of the branch outlets to the flow path outlets,
wherein a sum of cross-sectional areas of the plurality of transmission flow paths is greater than or equal to the cross-sectional area of the discharge port of the fluidic oscillator.

5. The housing equipment device of claim 1, having an intake opening that is located downstream of the discharge port of the fluidic oscillator and through which a fluid can be drawn in from open space.

6. The housing equipment device of claim 5, having a protrusion protruding in a fluid passage and located near the intake opening on an upstream side thereof.

7. The housing equipment device of claim 1,
wherein the fluidic oscillator includes a flow path having an inlet port and a single outlet, and the single outlet is the discharge port,
the housing equipment device further comprising a discharge mode switching unit that switches between a first discharge mode of discharging a straight flow through the discharge port and a second discharge mode of discharging a wavy flow through the discharge port,
the discharge mode switching unit comprising a switching member that is part of a sidewall of the flow path and that can switch between the first discharge mode and the second discharge mode by rotating with respect to a flow path body.

8. The housing equipment device of claim 7,
wherein, in a circumferential surface of the switching member surrounding a rotational axis line of the switching member, a surface in contact with the flow path body includes at least one of a convex surface of partial cone shape or a convex surface of partial cylinder shape, and
wherein a surface of the flow path body in contact with the switching member includes at least one of a concave surface of partial cone shape or a concave surface of partial cylinder shape.

9. The housing equipment device of claim 7, further comprising a branch flow path connected to the discharge port and having a plurality of branch outlets, and a transmission flow path connected to the branch outlets and having a plurality of jetting ports communicating with open space,
wherein, in the transmission flow path, a straight flow jets out through each of the plurality of jetting ports in the first discharge mode, and a jet flow, of which at least one of the flow rate or the traveling direction varies with time, flows down through each of the plurality of jetting ports in the second discharge mode.
